(19) United States
(12) Patent Application Publication
(10) Pub. No.: US 2003/0188522 A1
(43) Pub. Date: Oct. 9, 2003

(54) Seedpod harvester

(76) Inventor: Clell Robinson SR., Summerfield, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/403,906

(22) Filed: Mar. 31, 2003

Related U.S. Application Data
(63) Continuation-in-part of application No. 09/789,218, filed on Feb. 20, 2001, now Pat. No. 6,539,695.
(60) Provisional application No. 60/184,472, filed on Feb. 23, 2000.

(51) Int. Cl. A01D 46/00

(52) U.S. Cl. 56/328.1

(57) ABSTRACT

A seed pod harvesting apparatus for attachment to a harvester to assist in the bunching and lifting of a plant for harvesting of root crops like peanuts. The seed pod harvesting apparatus having at least one pair of horizontally positioned snouts mounted to a frame in a spaced relationship, the snouts counter-rotate such that as a row of seed pod plants pass between the pair of snouts, the snouts assist in bunching and lifting of the seed pod plants as the harvester travels forward. The snouts are cone-shaped having a nose of the snout which is forward facing. The seed pod harvesting apparatus also including a digging component positioned between the pair of snouts for grasping the plant portion of the seed pod plant as the seed pod plant passes between the pair of snouts and pulling the plant from the ground.

### CROSS-REFERENCE TO A RELATED APPLICATION

This application is a continuation-in-part application claiming the benefit of U.S. patent application Ser. No. 09/789,218 filed Feb. 20, 2001, incorporated herein by reference which in turn claims the benefit of U.S. Provisional Application No. 60/184,472, filed Feb. 23, 2000, incorporated herein by reference.

### BACKGROUND OF THE INVENTION

1. Field of the Invention

The present invention relates to a device for digging and harvesting seed pods from plant roots, in particular, an improved device for digging and harvesting peanuts.

2. Description of the Related Art

Unlike many crops, peanuts have a very short harvest window in which the peanuts may be harvested while obtaining close to the maximum yield. If the peanuts are harvested too early, a considerable amount of the crop will be immature and unusable. If the peanuts are harvested too late, many of the peanuts will have rotted, and the effective yield will be decreased. While the exact harvest window varies by the type of peanut, a typical harvest time for peanuts is 145 days, with the harvest window being plus or minus four days. This narrow window requires that farmers harvest the peanuts as rapidly as possible.

The conventional method of harvesting the peanuts from the peanut plants is performed manually. Farmers manually dig up the peanut plant, exposing the plant root system and peanuts. The soil is shaken from the root system exposing the peanuts, then the peanuts are removed and collected. The manual harvesting of peanuts takes many man-hours of labor, being inefficient and costly.

In an effort to decrease costs and increase efficiency, mechanical harvesters have been invented which dig up the peanut plants, exposing the plant roots system and peanuts. The peanut plants are first progressively dug from the ground exposing the plant root system and peanuts. The plants are then passed along a conveyer, where the soil is shaken from the plant root system. At the end of the conveyer, the plants are deposited on the ground in the inverted position, with the peanut being on top of the plant. Examples of such plant invertors are disclosed in U.S. Pat. No. 5,588,494 to Pickett, et al., for a Crop inverter and method for using same, and U.S. Pat. No. 5,257,486 to Hobbs, for a multiple row harvester for peanut crops. After inversion, the peanuts are subsequently manually picked from the roots. As with manual harvesting, this can be time consuming, and have high labor costs. Subsequently, there have been attempts to design a machine which both digs up the peanut plants and removes the peanuts from the plant root system. Examples of such devices are disclosed in U.S. Pat. No. 4,607,703 to Wang, for a peanut harvester and harvesting method, where the picking head uses rakes to strip the peanuts from the plant root system; U.S. Pat. No. 4,685,388 to Chen, for a Device to remove peanuts from the root thereof, where the picking head twists the peanuts until they are removed from the plant root; and U.S. Pat. No. 4,687,064 to Johnson, for Green peanut harvester, where the picking head removes the peanuts from the plant root system by using a saw-toothed picking comb. In addition to using a picking head, some have attempted to use combines to harvest peanuts, including U.S. Pat. No. 5,205,114 to Hobbs, for a Peanut Combine, and U.S. Pat. No. 5,980,382 to Brantley, et al., for a self-propelled peanut combine. The above-mentioned mechanical peanut harvesters have several disadvantages, including the tangling of the mechanical systems with the peanut plant's roots and the damaging of the harvested peanuts, be it the bruising or breaking of the peanut pods. Such problems can decrease the efficiency of the mechanical harvester and decrease the quality and quantity of the yield. Currently, there still remains a need for a simple, efficient and cost effective device for harvesting peanuts.

There also exist mechanical crop harvesters that utilize crop divider assemblies and “snouts” to assist in the digging up of the crop, including root crops. Examples of such devices are illustrated in U.S. Pat. No. 6,003,293, U.S. Pat. No. 5,577,562, U.S. Pat. No. 4,607,703, U.S. Pat. No. 4,538,404, U.S. Pat. No. 4,445,314, U.S. Pat. No. 4,377,062, and U.S. Pat. No. 4,232,744, all of which are incorporated herein by reference. In the '404 patent, for example, a crop divider is described as being positioned at the front of the harvester. The divider “divides” the crop by deflecting the plants' stalks as the harvesting machine proceeds forwardly through the field. The crop is divided into discrete rows for efficient cutting and handling by the harvesting machine. A crop divider can include a pointed “snout” at its front most end, the snout assisting in the dividing function as described above. These snouts rely on forward motion to become efficient and are used mostly with corn and bean harvesting equipment. These types of harvesters have been perfected to the degree that the machine is capable of traveling at a high ground speed which makes a stationary snout efficient to do the job of gathering and bunching foliage such as corn, beans, and other related crops. Most harvesting, such as corn, beans, and cotton, the plant is left in the ground while the fruit or the like is removed. Root crops, such as peanuts, require the plant to be removed from the ground. As such, a stationary snout, especially one at ground level and traveling at a slow speed would not perform adequately and could get jammed under the soil.

All patents, patent applications and publications referred to or cited herein, or from which a claim for benefit of priority has been made, including: U.S. Pat. No. 3,989,111 to Hobbs, U.S. Pat. No. 4,230,188 to Paulk, U.S. Pat. No. 4,232,744 to Thompson, U.S. Pat. No. 4,257,486 to Hobbs, U.S. Pat. No. 4,607,703 to Wang, U.S. Pat. No. 4,685,388 to Chen, U.S. Pat. No. 4,687,064 to Johnson, U.S. Pat. No. 5,205,114 to Hobbs, U.S. Pat. No. 5,577,562 to Gresham, U.S. Pat. No. 5,588,494 to Pickett, et al., and U.S. Pat. No. 5,980,382 to Brantley, et al. are incorporated by reference in their entirety to the extent they are not inconsistent with the explicit teachings of this specification.

### BRIEF SUMMARY OF THE INVENTION

The present invention provides a foliage-bunching device for attachment to a harvester to assist in the bunching and lifting of the plant for harvesting of root crops like peanuts. The foliage-bunching device may be attached to a mechanical harvester. For example, the foliage-bunching device may be attached to the digging end of a digger/shaker or digger/shaker/inverter mechanical harvesting machine or similar machine that harvests root crops like peanuts. The foliage-bunching device will assist in the digging-up of the peanut plants, the plants may then be conveyed to a harvesting head, for harvesting and collection of the peanuts.

In one embodiment of the invention, a seed pod harvesting apparatus for connecting to a harvester to assist in the bunching and lifting of seed pod plants for harvesting includes at least one pair of horizontally positioned snouts mounted to a frame in a spaced relationship, the snouts counter-rotate such that as a row of seed pod plants pass between the pair of snouts, the snouts assist in bunching and lifting of the seed pod plants as the harvester travels forward. The snouts are cone-shaped having a nose of the snout which is forward facing. The nose of the snout may be positioned at ground level, below ground level or above ground level. The horizontal and vertical position of the snout is adjustable and the snout may be spring mounted. The rotation of the snout provided by an inner shaft connected to a motor.

In another embodiment, the seed pod harvesting apparatus further includes at least one pair of vertically positioned shields mounted toward the rear of the snouts. The shields preferably have a curved front face for directing the seed pod plants therebetween. In one embodiment, the shields comprise a cone-shaped member cut substantially in half along a vertical axis resulting in a left and a right portion, each of said portions making a pair of shields, said pair of shields positioned vertically toward the rear and above the pair of snouts.

In another embodiment, the seed pod harvesting apparatus further includes a digging component positioned between the pair of snouts for grasping the plant portion of the seed pod plant as the seed pod plant passes between the pair of snouts and pulling the plant from the ground. The digging component may include a conveyor for carrying the plant rearward toward a harvesting section.

### BRIEF DESCRIPTION OF THE DRAWINGS

FIG. 1 shows a side view of the foliage-bunching device attached to a single-row mechanical harvesting machine.

FIG. 2 shows a top view of the foliage-bunching device attached to a single-row mechanical harvesting machine.

FIG. 3 shows a top view of the foliage-bunching device for multi-row harvesting.

FIG. 4 shows an enlarged and cut-away view of the foliage-bunching device.

FIG. 5 shows a perspective view of a harvesting head of one embodiment of the present invention.

FIG. 6 shows a perspective view of the harvesting section of one embodiment of the present invention.

FIG. 7 shows a perspective view of the shaftless harvesting head of another embodiment of the present invention.

FIG. 8 shows a perspective view of the self-cleaning means of the present invention.

### DETAILED DISCLOSURE OF THE INVENTION

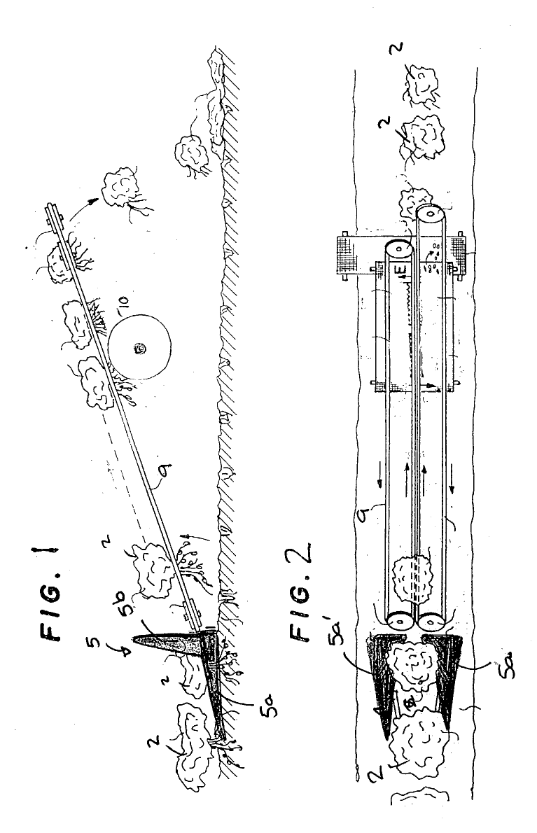

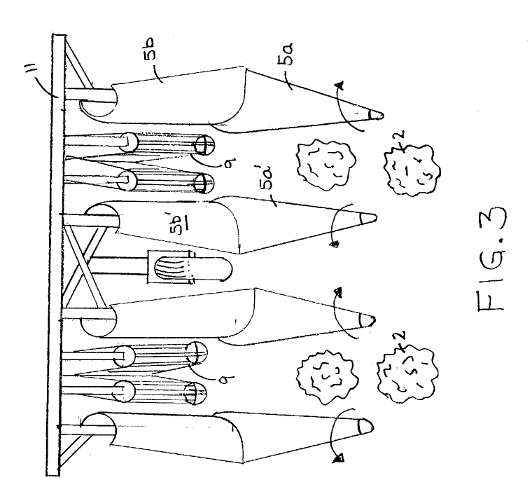

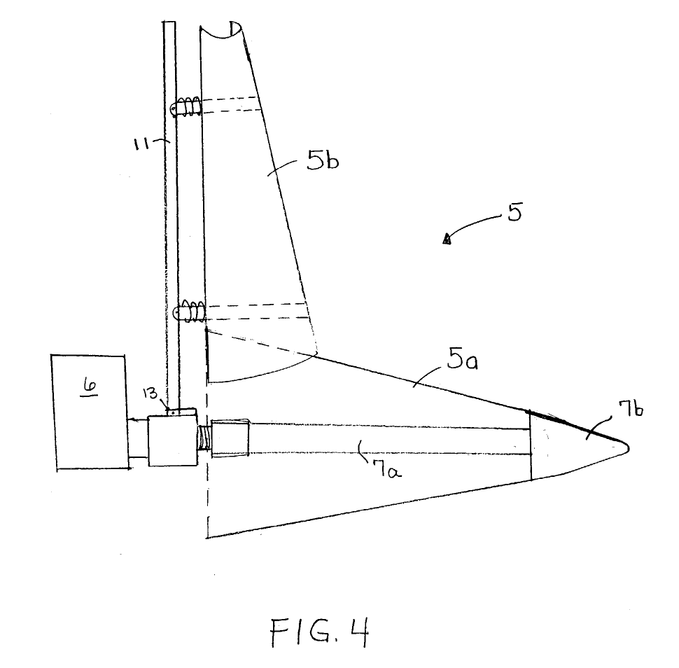

In the device as shown in FIGS. 1-4, the present invention provides in one embodiment a foliage-bunching device 5 (also referred to herein as a seed pod harvesting apparatus) for attachment to a harvester to assist in the bunching and lifting of the plant 2 for harvesting of root crops like peanuts. The foliage-bunching device 5 includes a pair of horizontally positioned cone-shaped snouts 5a and 5a′ for each discrete plant row. In one embodiment, the snouts rotate, preferably at different RPMs and at either rotation (clockwise or counterclockwise). A motor 6 is provided to cause the rotation. In one embodiment, a center shaft 7a disposed within the snout is connected to the motor 6 to provide rotation. The shaft 7a terminates at an end forming a nose 7b and has an outer covering forming the cone-shaped snout 5a. The shaft 7a is of sufficient diameter and length to support the outer covering and a coupling to the motor 6 (preferably a hydraulic fluid motor). The motor 6 may then be attached to the framework 11 of the mechanical harvester.

The nose 7b of each cone-shaped snout 5a preferably comes in contact with the foliage 2 at ground level or below ground level. By having a pair of snouts 5a and 5a′ positioned on each side of the plant and rotating in opposite directions, plants or foliage are bunched and lifted into an upright position as the harvester travels forward.

To support the foliage-bunching device 5, a hinge 13 is provided that will allow vertical motion of the snout 5a so that it can be adjusted to the correct height above or below the ground, as desired. Preferably, the frame 11 will include a double or split frame to give access for spring loading to support the weight of the snout 5a and allow movement in the event of external forces exerted on the snout 5a.

The advantage of rotating snouts is that the snouts will gather and bunch and lift foliage, such as peanut plants, in an upright position so a belt or chain can pull the plant from the ground for later seed pod removal by a harvesting head, such as harvesting head 10. This solves the problem of gathering and positioning foliage in an upright position at a slow ground speed where a conventional snout (non-rotating) will not work.

In another embodiment, the foliage-bunching device 5 further includes a pair of vertically positioned shields 5b and 5b′ positioned above each snout 5a and 5a′. The shields act as a guide for foliage and are positioned on the supporting framework 11. The shields guide the foliage towards the conveyor 9. In a specific embodiment, the shield would equal ½ of the cone-shaped snout as part of the framework with the small end of the shield in the up position. The large or bottom end of the shield would be concaved to match the curvature of the large end of the cone-shaped snout. The shields could be designed for left and right sides of the row. Any suitable design of the shield to provide the desired function of guiding the foliage is contemplated herein.

Once the plants 2 are bunched and lifted by the foliage-bunching device 5, a plant conveyor 9 (belt, chains, or the like) positioned just above the level of the ground at a suitable height to grasp the plant carries the plant rearward and upward to cause the roots of the plants containing the peanuts (for example) to be pulled from the ground. The conveyor 9 then carries the plant to the harvesting part of the machine that may be in the form of a standard digger/shaker or digger/shaker/inverter or the harvesting head 10 described herein. The conveyor 9 causes the roots of the plants 2 to be passed over a picking element, such as harvesting head 10.

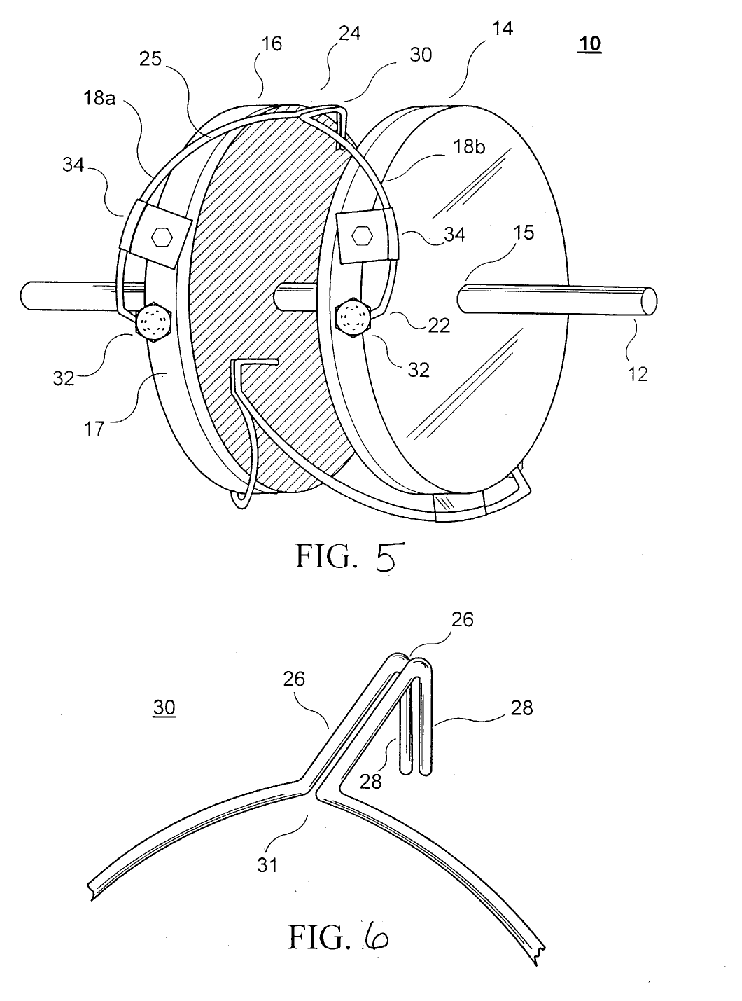

In the device as shown in FIG. 5, the harvesting head 10 includes three components for performing the requisite function, namely a shaft 12, a pair of circular hubs 14 and 16, and at least one set of tines 18, where a set of tines comprises a pair of tine members 18a and 18b. One tine member is the mirror image of the other tine member. The first hub 14 and second hub 16 are securely mounted onto the shaft 12 through their central axes 15, where the first and second hubs 14 and 16 are parallel to one another. The diameter of the first and second hub 14 and 16 is of a sufficient size so that the shaft is below the flow of peanuts. In a preferred embodiment, the diameter of the hubs 14 and 16 is about 10 to 12 inches. Additionally, the distance between the first hub 14 and second hub 16 is such that a peanut plant's root system can pass between the hubs 14 and 16.

The set of tines 18 comprises a pair of tine members 18a and 18b, where a first tine member 18a is the mirror image of the second tine member 18b, mounted to the first and second hub 14 and 16. The first tine member 18a comprises a proximal end 22 and a distal end 24, where the proximal end 22 is affixed to the outer edge 17 of the first hub 14. The first tine member 18a is removably affixed to the first hub 14, such that the tine member 18a can be replaced when damaged or worn out. In a preferred embodiment, the tine member 18a is secured to the hub 14 with a bolt 32 which is passed through an eye located at the proximal end 22 of the first tine member 18a. Additionally, a secondary bracket 34 is used to secure the tine member 18a to the hub 14 and also maintain the tine member 18a in the proper orientation. The body 25 of the tine comprises an arch which matches the arch of the hub 14 and is at an angle such that the distal end 24 is positioned midway between the first hub 14 and second hub 16. The distal end 24 comprises a first section 26 and a second section 28, where the first section 26 is parallel to the hub 14, and the second section 28 is perpendicular 5 to the first section 26, directed towards the shaft 12 as shown in FIG. 6. The first section 26 and second section 28 are of sufficient lengths to remove the peanuts from the peanut plant root system. The second tine member 18b is mounted onto the second hub 16 in the same manner as the first tine member 18a onto the first hub 14 and as a mirror image of the first tine member 18a, such that the distal ends 24 of the first tine member 18a and second tine member 18a compress to form the elongated “L” shaped harvesting section 30 and the bodies 25 form a “V” shaped channeling section 31. The harvesting section 30 is spring loaded in compression and can automatically adjust for different sized root systems.

In alternative embodiments, the diameter of the hubs 14 and 16 and the distance between the hubs 14 and 16 may be of different sizes and lengths to accommodate different size root systems for different plant species.

In an alternative embodiment, the shaft 12 has a stationary cover or shield mounted between the first and second hubs 14 and 16, to prevent any wrapping or accumulation of the plant roots about the shaft 12.

In a preferred embodiment, the harvesting head 10 has at least three sets of tines 18 mounted onto the hubs 14 and 16, where the sets of tines 18 are mounted at equal distances along the circumference of the hubs 14 and 16 from each other. However, any number of sets is contemplated herein.

In operation, the harvesting head 10 is mounted onto any suitable device which can rotate the harvesting head 10. The harvesting head 10 is positioned such that the peanut plant roots hang above the shaft 10. As the harvesting head 10 is rotated, the peanut plant's root system enters the “V” shaped channel section 31 of a set of tines 18. The plant's roots are funneled through the “N” shaped channeling section 31 into the harvesting section 30. The plant's roots apply a force onto the harvesting section 30 which is sufficient in strength to separate the distal ends 24 of the tine members 18a and 18b, opening the “L” shaped harvesting section 30. The plant's roots then pass into the first leg 26 of the harvesting section 30, where the plant's roots are bunched and aligned. The plant's roots then pass into the second leg 28 of the harvesting section 30. As the harvesting head 10 rotates, the second leg 28 becomes perpendicular to the plant's roots and pulls the peanuts from the plant's roots so that the peanuts are removed and can fall into a catch bin or other collection means.

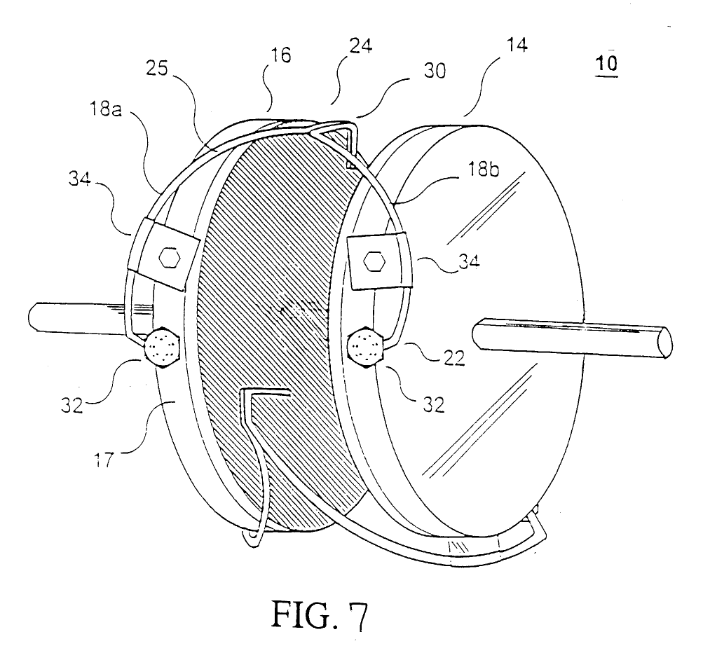

In an alternative embodiment, as shown in FIG. 7, the subject invention comprises a pair of circular hubs 14 and 16, and at least one set of tines 18, where a set of tines 18 comprises a pair of tine members 18a and 18b. One tine member is the mirror image of the other tine member. The first time member 18a is removably affixed to the first hub 14, such that the first tine member 18a can be replaced when damaged or worn. The second tine member 18b is mounted onto the second hub 16 in the same manner as the first tine member 18a is mounted onto the first hub 14.

In operation, the circular hubs 14 and 16 are individual mounted onto a suitable device, such that the circular hubs 14 and 16 are parallel to each other. The hubs 14 and 16 are aligned such that the distal ends 24 of the first tine member and 18a the second tine member 18b compress to form the elongated substantially “L” shaped harvesting section 30 and the bodies from a substantially “V” shaped channeling section 31.

The hubs 14 and 16 are connected to a synchronized drive means, such that the first and second tines 18a and 18b remain in alignment as hubs 14 and 16 rotate. For example, the drive means can include, but not be limited to, the hubs 14 and 16 each being connected to a single drive motor with a pair of chains or belts. The single drive motor simultaneously rotates the hubs 14 and 16 such the first and second tines 18a and 18b remain in alignment.

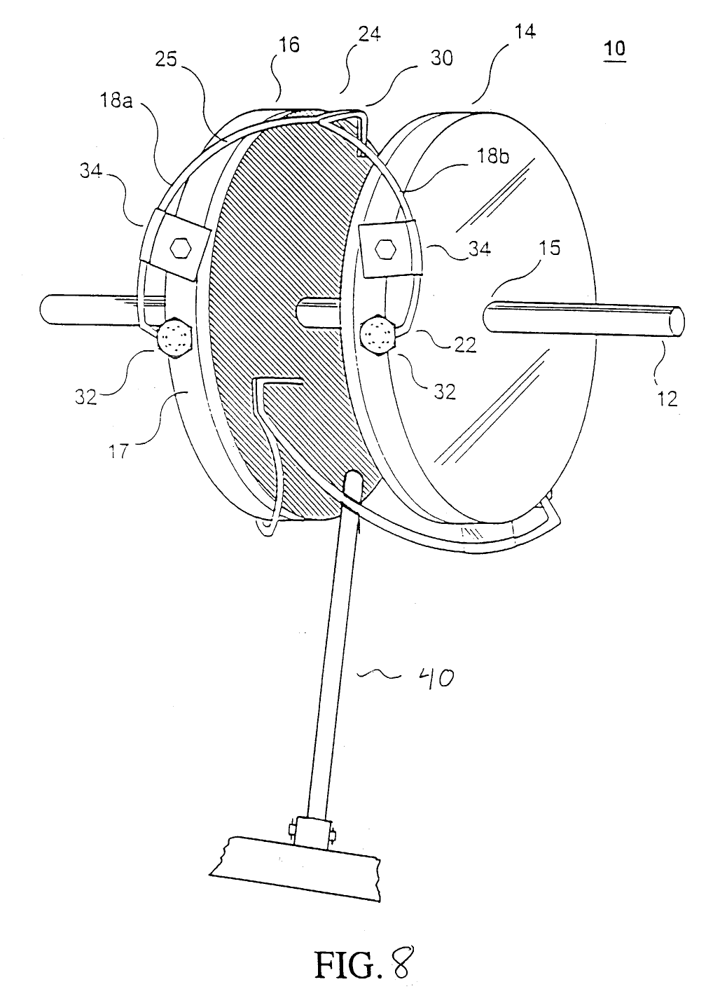

In a further embodiment, as shown in FIG. 8, the subject invention further comprises a self-cleaning means. In an example, the self-cleaning means comprises a rod 40 centrally mounted and parallel to the hubs 14 and 16, such that as the hubs 14 and 16 rotate the rod passes through the substantially “V” shaped channeling section 31 and substantially “L” shaped harvesting section 30, removing debris. The rod may be permanently positioned or movable into its cleaning position as desired.

In an alternative embodiment, the harvesting head 10 is mounted onto a digger-shaker or a digger-shaker-inverter. A digger-shaker utilizes a digging means, a conveying means and a shaking means. The digger-shaker may be of an entirely conventional configuration and construction such as disclosed, for example, in U.S. Pat. No. 3,726,345, the details of which are incorporated by reference.

It should be understood that the examples and embodiments described herein are for illustrative purposes only and that various modifications or changes in light thereof will be suggested to persons skilled in the art and are to be included within the spirit and purview of this application and the scope of the appended claims.

1. A seed pod harvesting apparatus for connecting to a harvester to assist in the bunching and lifting of seed pod plants for harvesting comprising at least one pair of horizontally positioned snouts mounted to a frame in a spaced relationship, said snouts counter-rotate such that as a row of seed pod plants pass between the pair of snouts, said snouts assist in bunching and lifting of the seed pod plants as the harvester travels forward.

2. The seed pod harvesting apparatus of claim 1 wherein said snouts are cone-shaped having a nose of said snout which is forward facing.

3. The seed pod harvesting apparatus of claim 2 wherein said nose of said snout is positioned at ground level.

4. The seed pod harvesting apparatus of claim 2 wherein said nose of said snout is positioned below ground level.

5. The seed pod harvesting apparatus of claim 2 wherein said nose of said snout is positioned above ground level.

6. The seed pod harvesting apparatus of claim 1 wherein the horizontal position of said snout is adjustable.

7. The seed pod harvesting apparatus of claim 1 wherein the vertical position of said snout is adjustable.

8. The seed pod harvesting apparatus of claim 1 wherein the snout is spring mounted.

9. The seed pod harvesting apparatus of claim 1 further comprising at least one pair of vertically positioned shields mounted toward the rear of said snouts.

10. The seed pod harvesting apparatus of claim 9 wherein said shields comprise a curved front face for directing the seed pod plants therebetween.

11. The seed pod harvesting apparatus of claim 9 wherein said shields comprise a cone-shaped member cut substantially in half along a vertical axis resulting in a left and a right portion, each of said portions making a pair of shields, said pair of shields positioned vertically toward the rear and above the pair of snouts.

12. The seed pod harvesting apparatus of claim 1 further comprising a digging component positioned between the pair of snouts for grasping the plant portion of the seed pod plant as the seed pod plant passes between the pair of snouts and pulling the plant from the ground.

13. The seed pod harvesting apparatus of claim 12 wherein said digging component comprises a conveyor for carrying the plant rearward toward a harvesting section.

14. A seed pod harvesting apparatus for connecting to a harvester to assist in the bunching and lifting of seed pod plants for harvesting comprising:
(a) at least one pair of horizontally positioned snouts mounted to a frame in a spaced relationship, said snouts counter-rotate such that as a row of seed pod plants pass between the pair of snouts, said snouts assist in bunching and lifting of the seed pod plants as the harvester travels forward; and
(b) at least one pair of vertically positioned shields mounted toward the rear of said snouts.

15. The seed pod harvesting apparatus of claim 14 further comprising a digging component positioned between the pair of snouts for grasping the plant portion of the seed pod plant as the seed pod plant passes between the pair of snouts and pulling the plant from the ground.

16. The seed pod harvesting apparatus of claim 15 wherein said digging component comprises a conveyor for carrying the plant rearward toward a harvesting section.

17. The seed pod harvesting apparatus of claim 1 wherein the counter-rotation of the snouts is provided by an inner shaft driven by a motor.

18. The seed pod harvesting apparatus of claim 1 wherein the rotation speed of the counter-rotating snouts is variable.
